(19) United States
(12) Patent Application Publication
(10) Pub. No.: US 2023/0421971 A1
(43) Pub. Date: Dec. 28, 2023

(54) HEARING AID COMPRISING AN ACTIVE OCCLUSION CANCELLATION SYSTEM

(71) Applicant: Oticon A/S, Smoerum (DK)

(72) Inventors: Karsten Bo RASMUSSEN, Birkeroed (DK); Svend Oscar PETERSEN, Smoerum (DK)

(21) Appl. No.: 18/339,265

(22) Filed: Jun. 22, 2023

(30) Foreign Application Priority Data
Jun. 24, 2022 (EP) 22181057.5

(51) Int. Cl. H04R 25/00

(52) U.S. Cl. CPC H04R 25/453; H04R 2225/021; H04R 2225/025; H04R 2225/57

(57) ABSTRACT

Disclosed herein are embodiments of a hearing aid configured to be worn by a user at or in an ear of the user and having an ITE-part adapted for being located at or in an ear canal of the user. The hearing aid can include an active occlusion cancellation system (AOCS) for providing an acoustic anti-occlusion signal configured to cancel or diminish a sense of occlusion of the user when the user is speaking, or otherwise is using his or her voice, or when otherwise moving the jaws. Methods of operating a hearing aid are further disclosed.

### TECHNICAL FIELD

Occlusion is a problem for many hearing aid users. Own voice sounds may be perceived distorted and loud, and body generated sounds, such as chewing, become intrusive.

The present disclosure relates to anti-occlusion in hearing devices, e.g. hearing aids, e.g. in hearing aids comprising a loudspeaker located in and ear canal of a user in combination with a BTE-part configured to be located behind an ear of the user of the hearing aid.

Known techniques exist for reducing occlusion. One way of solving the problem is by increasing the vent size (the term ‘vent’ being used for a ‘ventilation channel’) in a hearing aid or similar audio device. Increasing the vent size does, however, decrease the audiological performance in terms of noise reduction and low frequency amplification. Both these performance degradations are related to the sound transmission (escaping) through the vent. This sound transmission can be reduced by reducing the vent size. Having a small vent size will, however, lead to a build-up of body generated low frequency sound in front of the eardrum when the hearing aid user is speaking or eating. Therefore, a need for anti-occlusion persists.

Anti-occlusion (also termed ‘active occlusion cancellation’ in the present disclosure) is in the present context to be understood as the generation of a loudspeaker signal with similar amplitude and opposite phase as the occlusion signal in front of the eardrum. This acoustic signal partially cancels the body generated occlusion signal and thereby decreases the occlusion as experienced by the user. Technology for realizing such an anti-occlusion solution exists in the form of analogue or digital signal processing measuring the acoustic occlusion behind the hearing aid (in front of the eardrum) and generating the anti-occlusion signal to be emitted by the loudspeaker. This approach is particularly relevant for low frequencies, where occlusion is prominent, e.g. below 600 Hz. However, for small body worn audio devices such as hearing devices, e.g. hearing aids, the loudspeaker/hearing aid receiver (the term ‘receiver’ being often used synonymously with the term ‘loudspeaker’ in the field of hearing aids) may be insufficient to fully compensate the occlusion due to the limited acoustic output from the loudspeaker/hearing aid receiver at low frequencies.

An occlusion reduction scheme for a hearing aid is e.g. disclosed in US2008063228A1.

### SUMMARY

It is proposed to use a separate loudspeaker for generating the anti-occlusion signal—a loudspeaker which may be optimized for low frequency efficiency. This loudspeaker is preferably located at the end of the hearing device closest to the eardrum such as in an ear mould or speaker unit attached to a BTE-part of the hearing aid (such type of hearing aid sometimes being termed a ‘RITE’ style hearing aid (‘BTE’ and ‘RITE’ being short for ‘behind the ear’ and ‘receiver in the ear’, respectively). The loudspeaker is electrically connected—through a digital or analogue processing system- to an inward facing microphone measuring the occlusion signal in front of the eardrum. By using this approach, a dedicated fast acting signal processing system may be provided for solving or decreasing the occlusion problem. The normal loudspeaker, typically providing an amplified and noise reduced version of signals picked up by microphones (and/or received by wireless receiver(s)) of the hearing device, may e.g. be located in the BTE-part of the hearing aid (as is common for some hearing aid styles) and connected to the ear mould or speaker unit by an acoustic tube.

In the present application, the term loudspeaker is used instead of the term ‘receiver’ to mean a conventional electric to acoustic (output) transducer, whereas the term ‘audio receiver’ is used for an electromagnetic to electric (input) transducer providing an electric signal representing audio.

A Hearing Aid:

In an aspect of the present application, a hearing aid configured to be worn by a user at or in an ear of the user, is provided. The hearing aid comprises
an ITE-part adapted for being located at or in an ear canal of the user;
at least one first input transducer configured to provide corresponding at least one first electric input signal representing sound;
a hearing aid processor configured to provide a processed signal in dependence of said at least one electric input signal;
a first output transducer configured to play sound to the user in dependence of said processed signal, or a signal dependent thereon;
an active occlusion cancellation (AOC) system for providing an acoustic anti-occlusion signal configured to cancel or diminish a sense of occlusion of the user when the user is speaking, or otherwise is using his or her voice, or when otherwise moving the jaws; wherein the active occlusion cancellation system comprises
   an ear canal input transducer located in said ITE-part and configured to provide an electric ear canal input signal representing sound in said ear canal, when the user wears the hearing aid;
   an ear canal sound estimation unit configured to estimate sound in said ear canal and to provide an electric anti-occlusion signal in dependence of said electric ear canal input signal and said processed signal.

The hearing aid may further comprise a second output transducer located in said ITE-part configured to play sound to the user and to provide said acoustic anti-occlusion signal in dependence of said electric anti-occlusion signal.

Thereby an improved hearing aid may be provided.

A hearing aid according to the present disclosure aims at serving the combination of traditional hearing user needs (hearing loss compensation, comfort, discreetness) and occlusion free listening. Having two (e.g. mutually optimized) loudspeakers may provide the advantages of:
A dedicated ‘woofer’ in an ITE-part located in the ear that serves mostly AOC may provide a large low frequency output and a small phase shift, both needed for AOC.
A dedicated ‘tweeter’ in a BTE-part serves mid/high frequencies, required for hearing loss compensation. Such a receiver can be smaller than a traditional BTE receiver, accomplishing discreetness. Having an acoustic tube between the receiver and the ear canal enables potential acoustic optimization to boost mid- and high-frequencies, which would not be possible with the tweeter sitting in the ear canal.

The hearing aid may be configured to provide that the first input transducer faces the environment (e.g. has an inlet in a direction towards the environment of the user), when the hearing aid is worn by the user. The hearing aid may be configured to provide that the ear canal input transducer faces the eardrum (e.g. has an inlet in a direction towards the eardrum of the user), when the hearing aid is worn by the user.

The at least one first input transducer may comprise, at least two input transducers. The at least one first input transducer may comprise a microphone.

The ear canal input transducer may comprise a microphone or a vibration sensor.

The active occlusion cancellation system (e.g. the ear canal sound estimation unit) may be configured to provide a compensated processed signal (for presentation to the eardrum by the normal hearing aid loudspeaker) that is compensated by an amount corresponding to the part of the sound from the normal hearing aid loudspeaker that is cancelled by the acoustic anti-occlusion signal provided by the anti-occlusion loudspeaker. The active occlusion cancellation system (e.g. the ear canal sound estimation unit) is configured to provide the compensated processed signal in dependence of a compensation control signal provided in dependence of the electric ear canal input signal from the ear canal microphone (or from a signal originating therefrom) and the processed signal from the hearing aid processor.

The first output transducer (e.g. a normal hearing aid loudspeaker) may be configured to (e.g. solely) play the ‘desired sound’ intended for being played to the user to compensate for a hearing loss of the user (cf. e.g. the embodiment of FIG. 5C). The second output transducer may be configured to (e.g. solely) play the acoustic anti-occlusion signal intended to cancel occluded sound in the ear canal of the user.

The second output transducer may be specifically adapted to provide sound at frequencies below a threshold frequency. The threshold frequency may e.g. be smaller than or equal to 1 kHz, such as smaller than or equal to 600 Hz, e.g. smaller than or equal to 500 Hz.

An active occlusion cancellation (AOC) loudspeaker (here termed second loudspeaker) is preferably configured to perform optimally at low frequencies (e.g. ≤500 Hz) (e.g. to have a high output and a small phase shift/latency) whereas the “normal” hearing aid loudspeaker is optimized at having a high output at higher frequencies (e.g. around 3 kHz).

The hearing aid may be configured to provide that the first and second output transducers are fed different signals (to be played the eardrum).

The first and second output transducers may be configured to divide the tasks of playing sound in different (possibly overlapping) frequency ranges, between them. The first output transducer may be configured to play sound above a first threshold frequency (f_{th,1}). The second output transducer may be configured to play sound below a second threshold frequency (f_{th,2}). The first threshold frequency (f_{th,1}) may be smaller than of equal to the second threshold frequency (f_{th,2}). The first threshold frequency may e.g. be 600 Hz. The second threshold frequency may e.g. be 1000 Hz.

The first threshold frequency may be equal to the second threshold frequency. The (first and second) threshold frequency may be in the range between 400 Hz and 1000 Hz, e.g. between 400 Hz and 800 Hz.

The hearing aid may be a constituted by the ITE-part, e.g. be of the ITC-style (In-The-Canal), ITE-style (In-The-Ear) or CIC-style (Completely-In-the-Canal), e.g. where all components of the hearing aid are enclosed in and/or attached to) a housing configured to be located in or at the user's ear canal.

The hearing aid may comprise a BTE-part adapted for being located at or behind the ear of the user and a connecting element adapted for mechanically and electrically connecting said BTE-part and said ITE-part.

The hearing aid may comprise a connecting element for connecting two separate parts of the hearing aid, e.g. an earpiece adapted for being located at least partially in an ear canal and another part located elsewhere on the body of the user, e.g. at the ear of the user. The two separate parts of the hearing aid may comprise a processing part and an earpiece in wired or wireless communication with each other. The connecting element may comprise one or more electric wires in addition to or as an alternative to an acoustic propagation channel to thereby connect the BTE-part and the ITE-part electrically and/or acoustically. The ITE-part may be constituted by or comprise an earpiece.

The first output transducer may be located in the BTE-part. Thereby the first and second output transducers are located in two different physical entities (the BTE- and ITE-parts, respectively) making it easier to accommodate the two units. The at least one first input transducer may be located in the BTE-part or in the ITE-part or distributed between the BTE-part and the ITE-part. The ear canal microphone may e.g. be located in the ITE-part facing the ear drum. The second (separate) loudspeaker may e.g. be located in the ITE-part (facing the eardrum). The (first) normal hearing aid loudspeaker may e.g. be located in the ITE-part. The ear canal sound estimation unit may be located in the BTE-part or in the ITE-part, or distributed between the BTE-part and the ITE-part.

The at least one first input transducer may comprise an audio receiver, e.g. a wireless audio receiver.

The first or second output transducer may comprise a loudspeaker.

The connecting element may comprise an acoustic tube. The acoustic tube may be configured to guide sound from the first output transducer to the ITE-part. The ITE-part may be configured to guide sound received via the acoustic tube to the eardrum of the user, when the user wears the hearing aid. The connecting element may comprise one or more electrical conductors (e.g. electric wires) configured to electrically connect electric components of the BTE and ITE-parts. The one or more electrical conductors may e.g. be arranged to provide power to electric components in the ITE-part. The one or more electrical conductors may e.g. be arranged to transmit the processed signal or a signal dependent thereon (e.g. a further processed version of the processed signal from the hearing aid processor).

A ventilation channel may form part of the hearing aid, at least for pressure relief.

The ITE-part may comprise a ventilation channel configured to allow an exchange of air between a residual volume between the eardrum and the ITE-part and the environment (when the user wears the hearing aid).

The hearing aid may comprise an own voice detector configured to estimate whether or not, or with what probability, a given input sound, originates from the voice of the user and to provide an own voice control signal in dependence thereof. The ear canal sound estimation unit may be configured to provide said electric anti-occlusion signal in dependence of said own voice control signal.

The hearing aid may comprise a body conducted sound detector. The hearing aid may comprise a movement detector configured to detect a movement of the jaws of the user, and to provide a jaw movement control signal in dependence thereof.

The hearing aid may be configured to operate in different modes including an anti-occlusion-mode, wherein the active occlusion cancellation system is enabled. The hearing aid may be configured to enter or leave the anti-occlusion-mode in dependence of a control signal, e.g. comprising the own voice control signal and/or the jaw movement control signal.

The hearing aid may be configured to provide that the change of enabling and disabling the anti-occlusion cancellation system is associated with a fading scheme providing a gradual change over time from one mode of operation to another.

The hearing aid may be constituted by or comprising an air-conduction type hearing aid, a bone-conduction type hearing aid, or a combination thereof.

The hearing aid may be adapted to provide a frequency dependent gain and/or a level dependent compression and/or a transposition (with or without frequency compression) of one or more frequency ranges to one or more other frequency ranges, e.g. to compensate for a hearing impairment of a user. The hearing aid may comprise a signal processor for enhancing the input signals and providing a processed output signal.

The hearing aid may comprise an output unit for providing a stimulus perceived by the user as an acoustic signal based on a processed electric signal. The output unit may comprise an output transducer. The output transducer may comprise a loudspeaker for providing the stimulus as an acoustic signal to the user (e.g. in an acoustic (air conduction based) hearing aid). The output transducer may comprise a vibrator for providing the stimulus as mechanical vibration of a skull bone to the user (e.g. in a bone-attached or bone-anchored hearing aid). The output unit may (additionally or alternatively) comprise a transmitter for transmitting sound picked up-by the hearing aid to another device, e.g. a far-end communication partner (e.g. via a network, e.g. in a telephone mode of operation, or in a headset configuration).

The hearing aid may comprise an input unit for providing an electric input signal representing sound. The input unit may comprise an input transducer, e.g. a microphone, for converting an input sound to an electric input signal. The at least one first input transducer may comprise a wireless audio receiver for receiving a wireless signal comprising or representing sound and for providing an electric input signal representing said sound. The at least one first input transducer may comprise a vibration sensor, e.g. an accelerometer.

The wireless audio receiver and/or transmitter may e.g. be configured to receive and/or transmit an electromagnetic signal in the radio frequency range (3 kHz to 300 GHz). The wireless audio receiver and/or transmitter may e.g. be configured to receive and/or transmit an electromagnetic signal in a frequency range of light (e.g. infrared light 300 GHz to 430 THz, or visible light, e.g. 430 THz to 770 THz).

The hearing aid may comprise a directional microphone system adapted to spatially filter sounds from the environment, and thereby enhance a target acoustic source among a multitude of acoustic sources in the local environment of the user wearing the hearing aid. The directional system may be adapted to detect (such as adaptively detect) from which direction a particular part of the microphone signal originates. This can be achieved in various different ways as e.g. described in the prior art. In hearing aids, a microphone array beamformer is often used for spatially attenuating background noise sources. The beamformer may comprise a linear constraint minimum variance (LCMV) beamformer. Many beamformer variants can be found in literature. The minimum variance distortionless response (MVDR) beamformer is widely used in microphone array signal processing. Ideally the MVDR beamformer keeps the signals from the target direction (also referred to as the look direction) unchanged, while attenuating sound signals from other directions maximally. The generalized sidelobe canceller (GSC) structure is an equivalent representation of the MVDR beamformer offering computational and numerical advantages over a direct implementation in its original form.

The hearing aid may comprise antenna and transceiver circuitry allowing a wireless link to an entertainment device (e.g. a TV-set), a communication device (e.g. a telephone), a wireless microphone, or another hearing aid, etc. The hearing aid may thus be configured to wirelessly receive a direct electric input signal from another device. Likewise, the hearing aid may be configured to wirelessly transmit a direct electric output signal to another device. The direct electric input or output signal may represent or comprise an audio signal and/or a control signal and/or an information signal.

In general, a wireless link established by antenna and transceiver circuitry of the hearing aid can be of any type. The wireless link may be a link based on near-field communication, e.g. an inductive link based on an inductive coupling between antenna coils of transmitter and receiver parts. The wireless link may be based on far-field, electromagnetic radiation. Preferably, frequencies used to establish a communication link between the hearing aid and the other device is below 70 GHz, e.g. located in a range from 50 MHz to 70 GHz, e.g. above 300 MHz, e.g. in an ISM range above 300 MHz, e.g. in the 900 MHz range or in the 2.4 GHz range or in the 5.8 GHz range or in the 60 GHz range (ISM=Industrial, Scientific and Medical, such standardized ranges being e.g. defined by the International Telecommunication Union, ITU). The wireless link may be based on a standardized or proprietary technology. The wireless link may be based on Bluetooth technology (e.g. Bluetooth Low-Energy technology, e.g. LE Audio), or Ultra WideBand (UWB) technology.

The hearing aid may be or form part of a portable (i.e. configured to be wearable) device, e.g. a device comprising a local energy source, e.g. a battery, e.g. a rechargeable battery. The hearing aid may e.g. be a low weight, easily wearable, device, e.g. having a total weight less than 100 g, such as less than 20 g.

The hearing aid may comprise a ‘forward’ (or ‘signal’) path for processing an audio signal between an input and an output of the hearing aid. A signal processor may be located in the forward path. The signal processor may be adapted to provide a frequency dependent gain according to a user's particular needs (e.g. hearing impairment). The hearing aid may comprise an ‘analysis’ path comprising functional components for analyzing signals and/or controlling processing of the forward path. Some or all signal processing of the analysis path and/or the forward path may be conducted in the frequency domain, in which case the hearing aid comprises appropriate analysis and synthesis filter banks. Some or all signal processing of the analysis path and/or the forward path may be conducted in the time domain.

An analogue electric signal representing an acoustic signal may be converted to a digital audio signal in an analogue-to-digital (AD) conversion process, where the analogue signal is sampled with a predefined sampling frequency or rate fₛ, fₛ being e.g. in the range from 8 kHz to 48 kHz (adapted to the particular needs of the application) to provide digital samples xₙ (or x[n]) at discrete points in time tₙ (or n), each audio sample representing the value of the acoustic signal at tₙ by a predefined number N_{b} of bits, N_{b} being e.g. in the range from 1 to 48 bits, e.g. 24 bits. Each audio sample is hence quantized using N_{b} bits (resulting in 2^{Nb} different possible values of the audio sample). A digital sample x has a length in time of 1/fₛ, e.g. 50 μs, for fₛ=20 kHz. A number of audio samples may be arranged in a time frame. A time frame may comprise 64 or 128 audio data samples. Other frame lengths may be used depending on the practical application.

The hearing aid may comprise an analogue-to-digital (AD) converter to digitize an analogue input (e.g. from an input transducer, such as a microphone) with a predefined sampling rate, e.g. 20 kHz. The hearing aids may comprise a digital-to-analogue (DA) converter to convert a digital signal to an analogue output signal, e.g. for being presented to a user via an output transducer.

The hearing aid, e.g. the input unit, and or the antenna and transceiver circuitry may comprise a transform unit for converting a time domain signal to a signal in the transform domain (e.g. frequency domain or Laplace domain, Z transform, wavelet transform, etc.). The transform unit may be constituted by or comprise a TF-conversion unit for providing a time-frequency representation of an input signal. The time-frequency representation may comprise an array or map of corresponding complex or real values of the signal in question in a particular time and frequency range. The TF conversion unit may comprise a filter bank for filtering a (time varying) input signal and providing a number of (time varying) output signals each comprising a distinct frequency range of the input signal. The TF conversion unit may comprise a Fourier transformation unit (e.g. a Discrete Fourier Transform (DFT) algorithm, or a Short Time Fourier Transform (STFT) algorithm, or similar) for converting a time variant input signal to a (time variant) signal in the (time-)frequency domain. The frequency range considered by the hearing aid from a minimum frequency fₘᵢₙ to a maximum frequency fₘₐₓ may comprise a part of the typical human audible frequency range from 20 Hz to 20 kHz, e.g. a part of the range from 20 Hz to 12 kHz. Typically, a sample rate f s is larger than or equal to twice the maximum frequency fₘₐₓ, fₛ≥2fₘₐₓ. A signal of the forward and/or analysis path of the hearing aid may be split into a number NI of frequency bands (e.g. of uniform width), where NI is e.g. larger than 5, such as larger than 10, such as larger than 50, such as larger than 100, such as larger than 500, at least some of which are processed individually. The hearing aid may be adapted to process a signal of the forward and/or analysis path in a number NP of different frequency channels (NP≤NI). The frequency channels may be uniform or non-uniform in width (e.g. increasing in width with frequency), overlapping or non-overlapping.

The hearing aid may be configured to operate in different modes, e.g. a normal mode and one or more specific modes, e.g. selectable by a user, or automatically selectable. A mode of operation may be optimized to a specific acoustic situation or environment, e.g. a communication mode, such as a telephone mode. A mode of operation may include a low-power mode, where functionality of the hearing aid is reduced (e.g. to save power), e.g. to disable wireless communication, and/or to disable specific features of the hearing aid. A mode of operation may include an anti-occlusion-mode, wherein the active occlusion cancellation system is enabled or/disabled in dependence of a body-conducted sound detector (e.g. comprising an own voice control signal, e.g. provided by an own voice detector, and/or a movement control signal, e.g. provided by a movement detector (e.g. comprising an accelerometer)).

The hearing aid may comprise a number of detectors configured to provide status signals relating to a current physical environment of the hearing aid (e.g. the current acoustic environment), and/or to a current state of the user wearing the hearing aid, and/or to a current state or mode of operation of the hearing aid. Alternatively or additionally, one or more detectors may form part of an external device in communication (e.g. wirelessly) with the hearing aid. An external device may e.g. comprise another hearing aid, a remote control, and audio delivery device, a telephone (e.g. a smartphone), an external sensor, etc.

One or more of the number of detectors may operate on the full band signal (time domain). One or more of the number of detectors may operate on band split signals ((time-) frequency domain), e.g. in a limited number of frequency bands.

The number of detectors may comprise a level detector for estimating a current level of a signal of the forward path. The detector may be configured to decide whether the current level of a signal of the forward path is above or below a given (L-)threshold value. The level detector operates on the full band signal (time domain). The level detector operates on band split signals ((time-) frequency domain).

The hearing aid may comprise a voice activity detector (VAD) for estimating whether or not (or with what probability) an input signal comprises a voice signal (at a given point in time). A voice signal may in the present context be taken to include a speech signal from a human being. It may also include other forms of utterances generated by the human speech system (e.g. singing). The voice activity detector unit may be adapted to classify a current acoustic environment of the user as a VOICE or NO-VOICE environment. This has the advantage that time segments of the electric microphone signal comprising human utterances (e.g. speech) in the user's environment can be identified, and thus separated from time segments only (or mainly) comprising other sound sources (e.g. artificially generated noise). The voice activity detector may be adapted to detect as a VOICE also the user's own voice. Alternatively, the voice activity detector may be adapted to exclude a user's own voice from the detection of a VOICE.

The hearing aid may comprise an own voice detector for estimating whether or not (or with what probability) a given input sound (e.g. a voice, e.g. speech) originates from the voice of the user of the system. A microphone system of the hearing aid may be adapted to be able to differentiate between a user's own voice and another person's voice and possibly from NON-voice sounds.

The number of detectors may comprise a movement detector, e.g. an acceleration sensor. The movement detector may be configured to detect movement of the user's facial muscles and/or bones, e.g. due to speech or chewing (e.g. jaw movement) and to provide a (movement) detector signal indicative thereof. A detection of jaw movement may e.g. be provided by a movement detector, e.g. an accelerometer, possibly in combination with other sensors (e.g. a microphone, e.g. the at least one first input transducer or the ear canal input transducer), cf. e.g. EP3588981A1. A body conducted sound detector is e.g. described in EP3588985A1. Sounds originating from jaw movements and external acoustic sounds may be differentiated by measuring a correlation between the microphone (input transducer) and the movement detector (e.g. accelerometer) signals.

The hearing aid may comprise a classification unit configured to classify the current situation based on input signals from (at least some of) the detectors, and possibly other inputs as well. In the present context ‘a current situation’ may be taken to be defined by one or more of
a) the physical environment (e.g. including the current electromagnetic environment, e.g. the occurrence of electromagnetic signals (e.g. comprising audio and/or control signals) intended or not intended for reception by the hearing aid, or other properties of the current environment than acoustic);
b) the current acoustic situation (input level, feedback, etc.), and
c) the current mode or state of the user (movement, temperature, cognitive load, etc.);
d) the current mode or state of the hearing aid (program selected, time elapsed since last user interaction, etc.) and/or of another device in communication with the hearing aid.

The classification unit may be based on or comprise a neural network, e.g. a trained neural network.

The hearing aid may comprise an acoustic (and/or mechanical) feedback control (e.g. suppression) or echo-cancelling system. Adaptive feedback cancellation has the ability to track feedback path changes over time. It is typically based on a linear time invariant filter to estimate the feedback path but its filter weights are updated over time. The filter update may be calculated using stochastic gradient algorithms, including some form of the Least Mean Square (LMS) or the Normalized LMS (NLMS) algorithms. They both have the property to minimize the error signal in the mean square sense with the NLMS additionally normalizing the filter update with respect to the squared Euclidean norm of some reference signal.

The hearing aid may further comprise other relevant functionality for the application in question, e.g. compression, noise reduction, etc.

The hearing aid may comprise a hearing instrument, e.g. a hearing instrument adapted for being located at the ear or fully or partially in the ear canal of a user, e.g. a headset, an earphone, an ear protection device or a combination thereof.

Use:

In an aspect, use of a hearing aid as described above, in the ‘detailed description of embodiments’ and in the claims, is moreover provided. Use may be provided in a system comprising one or more hearing aids (e.g. hearing instruments), headsets, ear phones, active ear protection systems, etc., e.g. in handsfree telephone systems, teleconferencing systems (e.g. including a speakerphone), public address systems, karaoke systems, classroom amplification systems, etc.

A Method:

In an aspect, a method of operating a hearing aid configured to be worn by a user at or in an ear of the user, is furthermore provided. The hearing aid comprises
an ITE-part adapted for being located at or in an ear canal of the user;
at least one first input transducer configured to provide corresponding at least one first electric input signal representing sound;
a hearing aid processor configured to provide a processed signal in dependence of said at least one electric input signal;
a first output transducer configured to play sound to the user in dependence of said processed signal, or a signal dependent thereon;
an ear canal input transducer located in said ITE-part and configured to provide an electric ear canal input signal representing sound in said ear canal, when the user wears the hearing aid;
a second output transducer located in said ITE-part configured to play sound to the user; The method comprises
providing an acoustic anti-occlusion signal configured to cancel or diminish a sense of occlusion of the user when the user is speaking, or otherwise is using his or her voice, or when otherwise moving the jaws;
estimating sound in said ear canal and providing an electric anti-occlusion signal in dependence of said electric ear canal input signal and said processed signal.

The method may further comprise providing via said second output transducer an acoustic anti-occlusion signal to the user's ear canal in dependence of said electric anti-occlusion signal, wherein said second output transducer is specifically adapted to provide sound at frequencies below a threshold frequency.

It is intended that some or all of the structural features of the device described above, in the ‘detailed description of embodiments’ or in the claims can be combined with embodiments of the method, when appropriately substituted by a corresponding process and vice versa. Embodiments of the method have the same advantages as the corresponding devices.

A Binaural Hearing Aid System:

In a further aspect, a binaural hearing aid system comprising first and second hearing aids as described above, in the ‘detailed description of embodiments’, and in the claims, AND an auxiliary device is moreover provided. The first and second hearing aids may be configured to establish a communication link between them allowing a coordination of enabling and disabling the anti-occlusion cancellation system.

The task of enabling and disabling of the anti-occlusion cancellation system may be associated with a fading (gradually changing over time) from one mode of operation to another (to avoid sudden changes (artifacts, perceived by the user) in the audio output to the user).

The term ‘fading’ is in the present context to gradually (as opposed to abruptly) change (over time) from a first mode of operation (e.g. anti-occlusion in-active) to a second mode of operation (e.g. anti-occlusion active), e.g. starting from a first situation with a first parameter setting (e.g. a first program) to a second situation with a second parameter setting (e.g. a second program). Ideally, the fading should ensure that the user perceives the sound from the hearing aid during change from one mode of operation to another without annoying artifacts.

The binaural hearing aid system may be configured to apply a fading scheme enabling and/or disabling the anti-occlusion cancellation system.

A Hearing System:

In a further aspect, a hearing system comprising a hearing aid as described above, in the ‘detailed description of embodiments’, and in the claims, AND an auxiliary device is moreover provided.

The hearing system may be adapted to establish a communication link between the hearing aid and the auxiliary device to provide that information (e.g. control and status signals, possibly audio signals) can be exchanged or forwarded from one to the other.

The auxiliary device may comprise a remote control, a smartphone, or other portable or wearable electronic device, such as a smartwatch or the like.

The auxiliary device may be constituted by or comprise a remote control for controlling functionality and operation of the hearing aid(s). The function of a remote control may be implemented in a smartphone, the smartphone possibly running an APP allowing to control the functionality of the audio processing device via the smartphone (the hearing aid(s) comprising an appropriate wireless interface to the smartphone, e.g. based on Bluetooth or some other standardized or proprietary scheme).

The auxiliary device may be constituted by or comprise an audio gateway device adapted for receiving a multitude of audio signals (e.g. from an entertainment device, e.g. a TV or a music player, a telephone apparatus, e.g. a mobile telephone or a computer, e.g. a PC) and adapted for selecting and/or combining an appropriate one of the received audio signals (or combination of signals) for transmission to the hearing aid.

The auxiliary device may be constituted by or comprise another hearing aid. The hearing system may comprise two hearing aids adapted to implement a binaural hearing system, e.g. a binaural hearing aid system.

An APP:

In a further aspect, a non-transitory application, termed an APP, is furthermore provided by the present disclosure. The APP comprises executable instructions configured to be executed on an auxiliary device to implement a user interface for a hearing aid or a hearing system described above in the ‘detailed description of embodiments’, and in the claims. The APP may be configured to run on cellular phone, e.g. a smartphone, or on another portable device allowing communication with said hearing aid or said hearing system.

The APP and the hearing aid or binaural hearing aid system or hearing system may be configured to allow a user to initiate or terminate different modes of the hearing aid or binaural hearing aid system or hearing system including an anti-occlusion-mode, wherein the active occlusion cancellation system is enabled (or disabled). The APP and the binaural hearing aid system may be configured to initiate (or terminate) the anti-occlusion-mode synchronously in both hearing aids of the binaural hearing aid system. The APP and the binaural hearing aid system may be configured to apply a fading scheme when enabling and/or disabling the anti-occlusion cancellation system.

### BRIEF DESCRIPTION OF DRAWINGS

The aspects of the disclosure may be best understood from the following detailed description taken in conjunction with the accompanying figures. The figures are schematic and simplified for clarity, and they just show details to improve the understanding of the claims, while other details are left out. Throughout, the same reference numerals are used for identical or corresponding parts. The individual features of each aspect may each be combined with any or all features of the other aspects. These and other aspects, features and/or technical effect will be apparent from and elucidated with reference to the illustrations described hereinafter in which:

FIG. 1 shows an embodiment of a hearing aid according to the present disclosure,

FIG. 2A shows an embodiment of a BTE-style hearing aid comprising an occlusion cancellation system according to the present disclosure; and

FIG. 2B shows an embodiment of an ITE-style hearing aid comprising an occlusion cancellation system according to the present disclosure,

FIG. 3 shows a simplified block diagram of an embodiment of a hearing aid comprising a first embodiment of an active anti-occlusion cancellation system according to the present disclosure,

FIG. 4 shows a simplified block diagram of an embodiment of a hearing aid comprising a second embodiment of an active anti-occlusion cancellation system according to the present disclosure, and

FIG. 5A shows a conventional anti-occlusion system;

FIG. 5B shows a first embodiment of an anti-occlusion system with two loudspeakers according to the present disclosure; and

FIG. 5C shows a second embodiment of an anti-occlusion system with two loudspeakers according to the present disclosure.

The figures are schematic and simplified for clarity, and they just show details which are essential to the understanding of the disclosure, while other details are left out. Throughout, the same reference signs are used for identical or corresponding parts.

Further scope of applicability of the present disclosure will become apparent from the detailed description given hereinafter. However, it should be understood that the detailed description and specific examples, while indicating preferred embodiments of the disclosure, are given by way of illustration only. Other embodiments may become apparent to those skilled in the art from the following detailed description.

### DETAILED DESCRIPTION OF EMBODIMENTS

The detailed description set forth below in connection with the appended drawings is intended as a description of various configurations. The detailed description includes specific details for the purpose of providing a thorough understanding of various concepts. However, it will be apparent to those skilled in the art that these concepts may be practiced without these specific details. Several aspects of the apparatus and methods are described by various blocks, functional units, modules, components, circuits, steps, processes, algorithms, etc. (collectively referred to as “elements”). Depending upon particular application, design constraints or other reasons, these elements may be implemented using electronic hardware, computer program, or any combination thereof.

The electronic hardware may include micro-electronic-mechanical systems (MEMS), integrated circuits (e.g. application specific), microprocessors, microcontrollers, digital signal processors (DSPs), field programmable gate arrays (FPGAs), programmable logic devices (PLDs), gated logic, discrete hardware circuits, printed circuit boards (PCB) (e.g. flexible PCBs), and other suitable hardware configured to perform the various functionality described throughout this disclosure, e.g. sensors, e.g. for sensing and/or registering physical properties of the environment, the device, the user, etc. Computer program shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The present application relates to the field of hearing devices, e.g. hearing aids. The present disclosure relates specifically to anti-occlusion in hearing devices, e.g. hearing aids, e.g. in hearing aids comprising a separate, dedicate anti-occlusion, loudspeaker located in an ear canal of a user, e.g. in combination with a BTE-part configured to be located at or behind an ear (pinna) of the user of the hearing aid. The hearing aid may e.g. comprise or be constituted by an ITE-part configured to be located fully or partially in an ear canal of the user. The ITE-part may e.g. comprise an (e.g. customized) ear mould. The standard hearing aid loudspeaker may be located in a BTE-part or in an ITE-part.

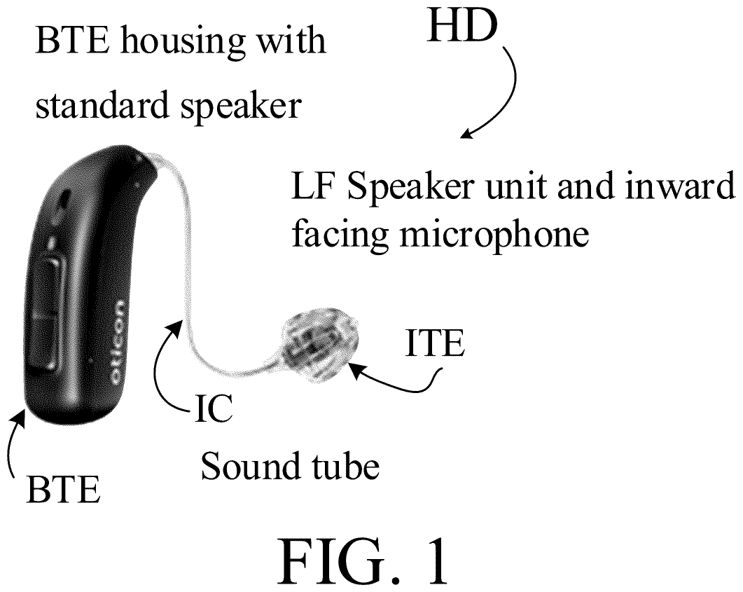

FIG. 1 shows an embodiment of a hearing aid according to the present disclosure. The hearing aid (HD) comprises a BTE-part (BTE) configured to be located at or behind an ear (pinna) of the user of the hearing aid and an ITE-part (ITE) configured to be located fully or partially in an ear canal of the user. The BTE-part and the ITE-part are connected by a connecting element (IC) adapted for mechanically and/or electrically connecting the BTE-part and the ITE-part. The BTE-part (BTE) comprises a housing wherein components of the hearing aid (e.g. electronic components) are enclosed, including a standard loudspeaker for presenting a sound signal representative of sound picked up by microphones of the hearing aid to the user. The connecting element (IC) comprises a sound tube (e.g. having a diameter of 0.9 mm to 1.3 mm) for propagating sound from the standard loudspeaker of the BTE-part to the ITE-part and thus to the user's eardrum, when the hearing aid is worn in or at an ear of the user. The ITE-part (ITE) comprises speaker unit comprising an (anti-occlusion) loudspeaker specifically adapted to counteract (predominantly low-frequency) sounds originating from the user (e.g. the user's voice or chewing movements, etc.) occluded in the ear canal. The hearing aid, e.g. the BTE-part and/or the ITE-part comprise(s) at least one (outward facing) microphone configured to pick up sound from the environment of the hearing aid, and to provide at least one electric input signal representative thereof. The ITE-part comprise(s) at least one (inward facing) microphone configured to pick up sound in the ear canal (e.g. from the residual volume between the ITE-part and the eardrum, when the hearing aid is mounted on the user as intended), and to provide at least one electric input signal representative thereof. The electric input signal from the inward facing microphone is used to estimate an anti-occlusion signal to be played by the anti-occlusion loudspeaker.

It is proposed to use a separate loudspeaker for generating the (acoustic) anti-occlusion signal—a loudspeaker which may be optimized for low frequency efficiency (e.g. between 50 Hz and 1 kHz). This loudspeaker is preferably located at the end of the hearing device closest to the eardrum such as in an ear mould or speaker unit attached to a BTE-part of the hearing aid (such type of hearing aid sometimes being termed a ‘RITE’ style hearing aid). The ear mould may alternatively constitute a standalone hearing aid. The loudspeaker is electrically connected—through a digital or analogue processing system—to an inward facing microphone measuring the occlusion signal in front of the eardrum. By using this approach, a dedicated fast acting signal processing system may be provided for solving or decreasing the occlusion problem.

The normal loudspeaker, typically providing an amplified and noise reduced version of signals picked up by microphones (and/or received by a wireless audio receiver) of the hearing device, may e.g. be located in a BTE-part of the hearing aid (as is common for some hearing aid styles) and connected to an ear mould or speaker unit by an acoustic tube.

The audiological signal path carrying external speech sounds and other external sounds to the hearing aid user is based on at least one microphone located further away from the eardrum such as in the body of a RITE or BTE hearing aid located behind the ear. The signal(s) from this or these microphones is(are) passed through a prior art hearing aid signal processing system (forward path) and passed on to a standard loudspeaker located outside the ear such as behind the ear, e.g. in the body (BTE-part) of a BTE instrument. The acoustic signal may be transmitted to the ear through a state-of-the-art acoustic tube (e.g. having a diameter in the range from 0.9 to 1.3 mm).

The proposal allows for a low frequency loudspeaker (e.g. a LF speaker unit) providing optimum performance in relation to the active occlusion cancellation system and for a discreet solution where the in-ear part is physically smaller than if the (standard) high frequency loudspeaker had also been placed in the ear. The location of the anti-occlusion loudspeaker (LF speaker unit) close to the eardrum is advantageous since it enables delivering the signal directly into the cavity in front of the eardrum without any phase distortions due to resonances in the acoustic tubing and with a short delay in this part of the acoustic system. Short delay and accurate phase are important performance parameters of the system in combination with vent size and maximum low frequency output from the (LF) loudspeaker.

Additionally, the inward facing microphone can also be used for optimizing the signal of the audiological signal path; The output sound level is monitored, and own voice detection can be introduced. The microphone can also capture own voice for communication purposes (phone calls etc.)

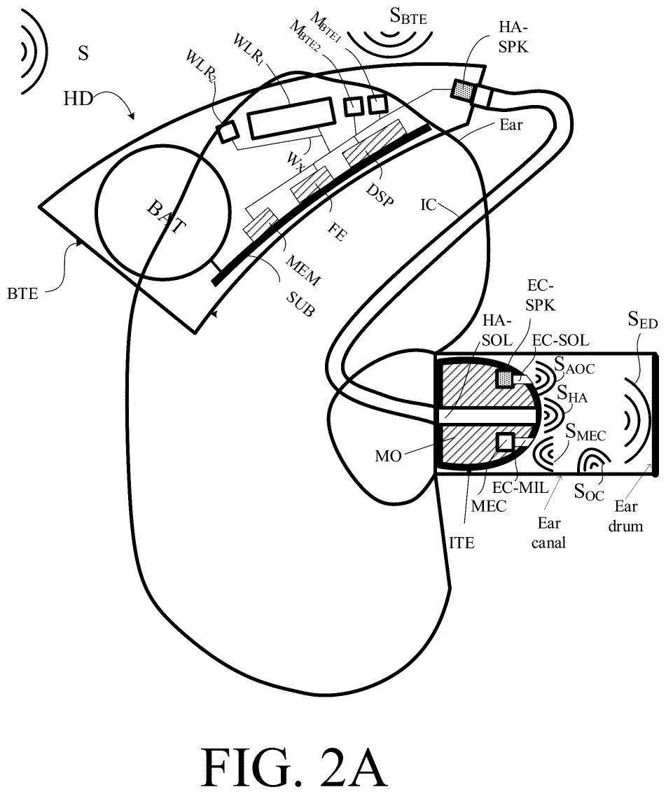

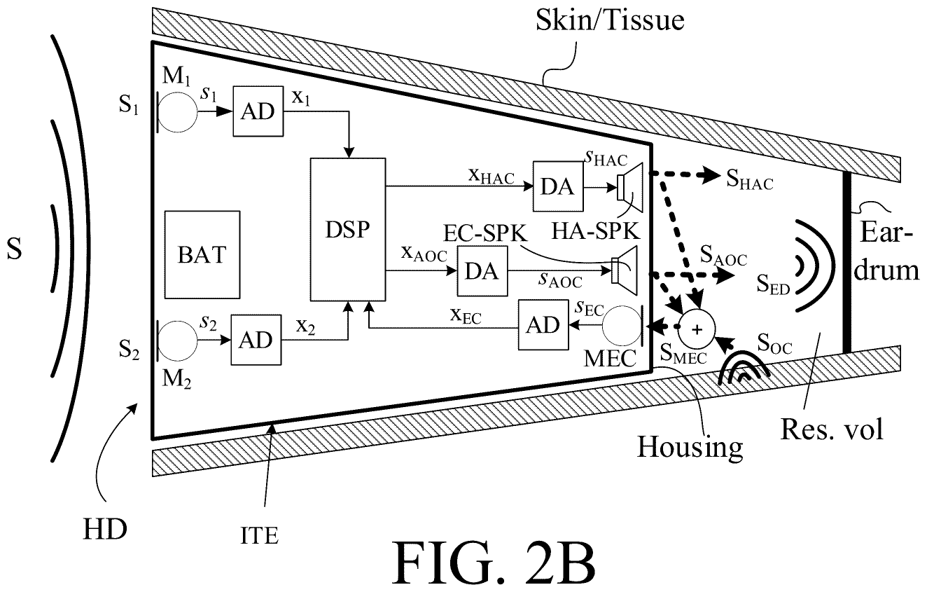

FIG. 2A shows an embodiment of a BTE-style hearing aid (HD) comprising an active occlusion cancellation system according to the present disclosure. The hearing device (HD) comprises a BTE-part (BTE) comprising a loudspeaker (HA-SPK) and an ITE-part (ITE) comprising an (possibly customized) earpiece, e.g. an ear mould (MO). The BTE-part and the ITE-part are connected by an acoustic propagation element (e.g. a hollow tube, IC). The BTE-part (BTE) is adapted for being located at or behind an ear of a user, and the ITE-part (ITE) is adapted for being located in or at an ear canal of a user's ear. The ITE-part comprises a through-going opening providing a loudspeaker sound outlet (SO) for the loudspeaker of the BTE-part (HA-SPK) allowing sound to be propagated via the connecting element (IC) to the ear drum (Eardrum) of the user (cf. sound field S_{HA} from the hearing aid loudspeaker (HA-SPK) contributing to sound field S_{ED} at the eardrum). The BTE-part and the ITE-part may (additionally, or alternatively) be electrically connected by electric wires located in or on the connecting element (IC), e.g. in addition to the acoustic propagation channel. The loudspeaker (HA-SPK) of the BTE-part is configured to play into the connecting element (IC) and further into the loudspeaker sound outlet (SO) of the ITE-part (providing sound field S_{HA}). The loudspeaker is connected by internal wiring in the BTE-part (cf. e.g. schematically illustrated as wiring Wx in the BTE-part) to relevant electronic circuitry of the hearing device, e.g. to a digital signal processor (DSP). The BTE-parts comprises first and second input transducers, e.g. microphones (M_{BTE1} and M_{BTE2}), respectively, which are used to pick up sounds from the environment of a user wearing the hearing aid (cf. sound field S_{BTE}). The ITE-part comprises an ear-mould (MO) and is intended to allow a relatively large sound pressure level (S_{HA}) to be delivered to the ear drum of the user (e.g. to a user having a severe-to-profound hearing loss). A part of the sound (S_{HA}) provided by the loudspeaker (HA-SPK) of the BTE-part may leak out along the interface between the ITE-part and the ear canal tissue. Such leaked sound may lead to unwanted feedback problems if picked by microphones of the hearing aid and amplified and presented to the user via the loudspeaker (HA-SPK). Such ‘acoustic feedback’ may be controlled by a proper feedback control system (e.g. (partly) compensated by an active noise cancellation system (ANC)).

The hearing aid further comprises an active occlusion cancellation system configured to cancel or diminish a sense of occlusion of the user when the user is speaking (or otherwise using his or her voice, or by otherwise moving the jaws, e.g. by chewing). This may e.g. be achieved by generating an acoustic anti-occlusion signal in the ear canal (more specifically in the residual volume between the ITE-part and the ear drum, when the ITE-part of the hearing aid is mounted in the user's ear canal). The active occlusion cancellation system is configured to generate the acoustic anti-occlusion signal so that it cancels or diminishes the acoustic signal in the residual volume originating from the user's own voice (etc.), e.g. from such sound propagated from the user's mouths to the residual volume via bone and flesh of the user's face.

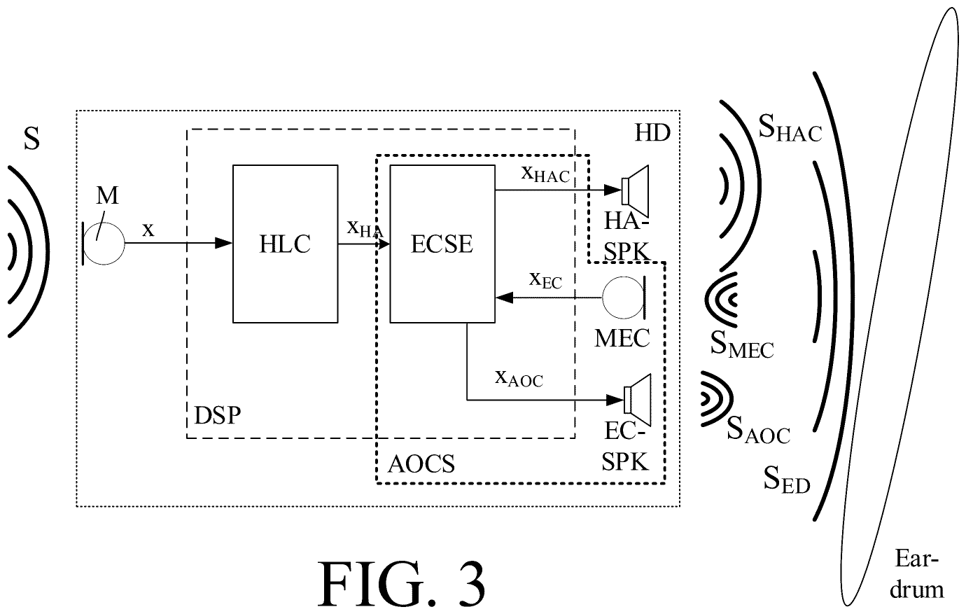

The active occlusion cancellation system (see ‘AOCS’ in FIG. 3) comprises a (second) (ear canal) input transducer (e.g. an ear canal microphone MEC, e.g. having a microphone inlet (EC-MIL) in a direction of the eardrum, as indicated in FIG. 2A) located in the ITE-part and configured to provide a (second) electric input signal representing sound (S_{OC}) in said ear canal, when the user wears the hearing aid. The active occlusion cancellation system further comprises an ear canal sound estimation unit configured to estimate sound in the ear canal in dependence of the (second) electric input signal (e.g. from the ear canal microphone MEC) and providing an electric ear canal signal representative of at least a part of the sound in the ear canal. As illustrated in FIG. 3, the ear canal sound estimation unit (ECSE) (included in the digital signal processor (DSP)) is configured to estimate sound (e.g. the sound pressure level) in the ear canal originating from the user's voice and to provide an electric anti-occlusion signal (x_{AOC}). The active occlusion cancellation system (AOCS) further comprises a (second) separate output transducer (EC-SPK, e.g. a loudspeaker) located in the ITE-part (and e.g. having a sound outlet in a direction of the eardrum, as indicated in FIG. 2A) and configured to play sound (S_{AOC}) to the user in dependence of the electric ear canal signal provided by the ear canal sound estimation unit. The ear canal sound estimation unit is configured to provide the electric ear canal signal to cancel or attenuate at least a part of the sound in the ear canal when played by the (second) separate output transducer. The sound at the eardrum S_{ED} is the sum of the contributions S_{HA} from the hearing aid loudspeaker (HA-SPK) propagated to the residual volume via the (inter)connecting element (IC) and the loudspeaker outlet (HA-SOL) of the ITE-part, the occluded sound (S_{OC}) originating from the user, and the anti-occlusion sound (S_{AOC}) delivered by the separate loudspeaker (EC-SPK) (via loudspeaker outlet EC-SOL) located in the ITE-part (these sound contributions being modified by respective acoustic transfer functions from their ‘point of arrival’ in the ear canal to the eardrum). A further contribution from directly propagated sound through a possible ventilation channel and/or other leakage paths from the environment to the residual volume at the eardrum may exist (the size of such contribution being dependent on the size of the leakage paths). Such further contribution may be handled by an active noise cancellation (ANC) system, cf. e.g. U.S. Pat. No. 8,229,127. Ideally, the anti-occlusion sound (S_{AOC}) cancels the occluded sound (S_{OC}) originating from the user's voice, jaw movements, etc. Thereby (ideally) only the desired sound (S_{HA}) provided by the hearing aid loudspeaker (HA-SPK) and originating from the environment (and/or from streamed sound received by the hearing aid) is the only sound perceivable by the user.

The separate output transducer (EC-SPK) is in the embodiment of FIG. 2A shown to have its own loudspeaker outlet. The outlet may however be coupled to the loudspeaker outlet (SO) of the loudspeaker (HA-SPK) of the BTE-part (providing the output sound of the forward path of the hearing aid). Thereby, one combined acoustic outlet may be provided.

The separate (second) output transducer (EC-SPK) (located in the ITE-part) may comprise a dedicated ‘woofer’ configured to provide a large low frequency output and a small phase shift (e.g. below 500 Hz). The first output transducer (HA-SPK) (located in the BTE-part) may comprise a dedicated ‘tweeter’ configured to serve mid/high frequencies (e.g. between 500 Hz and 8-10 kHz) required for hearing loss compensation.

The ITE-part comprises the ear canal input transducer (e.g. a microphone, MEC). The ear canal input transducer (MEC) faces the eardrum (and/or has a microphone inlet facing towards the eardrum) located so that it picks up sound in the ear canal (e.g. from the loudspeaker sound outlet (SO) of the ITE-part and own voice sound propagated through the skull bone and flesh) and provides an electric signal (x_{EC}) representative thereof.

The ITE-part may comprise a ventilation channel configured to allow an exchange of air between a residual volume between the eardrum and the ITE-part and the environment.

The hearing aid, e.g. the BTE-part (e.g. the DSP), further comprises an ear canal sound estimation unit configured to estimate sound in the ear canal (at least) in dependence of the ear canal electric input signal and providing an electric ear canal signal representative of at least a part of the sound in said ear canal. The ear canal sound estimation unit (ECSE, cf. FIG. 3) is configured to determine an electric anti-occlusion signal (x_{AOC}, cf. FIG. 3) in dependence of the electric ear canal input signal of the (eardrum facing) ear canal input transducer (MEC).

The partition of functional tasks between the BTE-part and the ITE-part may differ depending on the specific application and functionality of the hearing aid. Some of the processing, for example the processing of the active occlusion cancellation system (AOCS) may be located in the ITE-part to avoid communication related to the eardrum facing microphone and and/or the eardrum facing loudspeaker (MEC, EC-SPK) to/from the signal processor (DSP) of the BTE-part. Thereby the electric interface (IC) between the BTE- and ITE-parts may be simplified.

The hearing aid (HD) (here the BTE-part) further comprises two (e.g. individually selectable) wireless receivers (WLR₁, WLR₂) for providing respective directly received auxiliary audio input and/or control or information signals. The wireless receivers may be configured to receive signals from another hearing device (e.g. of a binaural hearing system) or from any other communication device, e.g. telephone, such as a smartphone, or from a wireless microphone or a T-coil, or a separate dedicated processing unit. The wireless receivers may be capable of receiving (and possibly also of transmitting) audio and/or control or information signals. The wireless receivers may be based on Bluetooth or similar technology (e.g. UWB) or may be based on near-field communication (e.g. inductive coupling).

The BTE-part comprises a substrate SUB whereon a number of electronic components (MEM, FE, DSP) are mounted. The BTE-part comprises a configurable signal processor (DSP) and memory (MEM) accessible therefrom. In an embodiment, the signal processor (DSP) form part of an integrated circuit, e.g. a (mainly) digital integrated circuit.

The hearing aid (HD) exemplified in FIG. 2A represents a portable device and further comprises a battery (BAT), e.g. a rechargeable battery, for energizing electronic components of the BTE-part and possibly the ITE-part.

The hearing aid (e.g. the processor (DSP)) may be adapted to provide a frequency dependent gain and/or a level dependent compression and/or a transposition (with or without frequency compression) of one or more frequency ranges to one or more other frequency ranges, e.g. to compensate for a hearing impairment of a user. The hearing aid may comprise a front-end processing unit (FE) for handling substantially analogue signals, e.g. to/from the input and output transducers.

The active occlusion cancellation system is further described in connection with FIGS. 3 and 4 and 5B, 5C.

FIG. 2B shows an embodiment of an ITE-style hearing aid comprising an occlusion cancellation system according to the present disclosure. The embodiment of FIG. 2B is similar to the embodiment of FIG. 2A, except that the essential components of the hearing aid are located in an ITE-part. The hearing aid (HD) comprises or consists of an ITE-part comprising a housing (Housing), which may be a standard housing aimed at fitting a group of users, or it may be customized to a user's ear (e.g. as an ear mould, e.g. to provide an appropriate fitting to the outer ear and/or the ear canal). The housing schematically illustrated in FIG. 2B has a symmetric form, e.g. around a longitudinal axis from the environment towards the ear drum (Eardrum) of the user (when mounted), but this need not be the case. It may be customized to the form of a particular user's ear canal. The hearing aid may be configured to be located in the outer part of the ear canal, e.g. partially visible from the outside.

To minimize leakage of sound (played by the hearing aid towards the ear drum of the user) from the ear canal, a good mechanical contact between the housing of the hearing aid and the Skin/tissue of the ear canal is aimed at. In an attempt to minimize such leakage, the housing of the ITE-part may be customized to the ear of a particular user.

The hearing aid (HD) comprises a number Q of microphones M_{q}, i=1, . . . , Q, here two (Q=2). The two microphones (M₁, M₂) are located in the housing with a certain (e.g. predefined) distance d between them, e.g. 8-10 mm, e.g. on a part of the surface of the housing that faces the environment when the hearing aid is operationally mounted in or at the ear of the user. The microphones (M₁, M₂) are e.g. located on the housing to have their microphone axis (an axis through the centre of the two microphones) point in a forward direction relative to the user, e.g. a look direction of the user (as e.g. defined by the nose of the user, e.g. substantially in a horizontal plane), when the hearing aid is mounted in or at the ear of the user. Thereby the two microphones are well suited to create a directional signal towards the front (and or back) of the user. The microphones are configured to convert sound (S₁, S₂) received from a sound field S around the user at their respective locations to respective (analogue) electric signals (s₁, s₂) representing the sound. The microphones are coupled to respective analogue to digital converters (AD) to provide the respective (analogue) electric signals (s₁, s₂) as digitized signals (x₁, x₂). The (digitized) electric input signals (x₁, x₂) are fed to a digital signal processor (DSP) for processing the audio signals (x₁, x₂), e.g. including one or more of spatial filtering (beamforming), (e.g. single channel) noise reduction, compression (frequency and level dependent amplification/attenuation according to a user's needs, e.g. hearing impairment), spatial cue preservation/restoration, etc. The digital signal processor (DSP) may e.g. comprise appropriate filter banks (e.g. analysis as well as synthesis filter banks) to allow processing in the frequency domain (individual processing of frequency sub-band signals). The digital signal processor (DSP) may e.g. comprise an ear canal sound estimation unit (ECSE) configured to estimate sound in the ear canal originating from the user's voice and to provide an electric anti-occlusion signal (x_{AOC}, see e.g. FIG. 3) according to the present disclosure. The digital signal processor (DSP) is configured to provide a processed signal (x_{HAC}) comprising a representation of the sound field S (e.g. including an estimate of a target signal therein). The processed signal (x_{HAC}) is fed to an output transducer (here a standard hearing aid loudspeaker (HA-SPK), e.g. via a digital to analogue converter (DA), for conversion of the processed (digital electric) signal (x_{HAC}) (or analogue version s_{HAC}) to a sound signal S_{AC}. In a specific anti-occlusion mode of operation according to the present disclosure the processed (hearing loss compensated) signal (x_{HAC}) may comprise a compensation of the attenuation provided by the anti-occlusion cancellation system according to the present disclosure.

The hearing aid comprises an active occlusion cancellation system (AOCS in FIG. 3) according to the present disclosure. In addition to the ear canal sound estimation unit (ECSE) mentioned above, the active occlusion cancellation system further comprises an ear canal input microphone (MEC) located in the ITE-part and configured to provide an electric ear canal input signal (x_{EC}) representing sound in the ear canal, when the user wears the hearing aid. The active occlusion cancellation system further comprises a second output transducer (EC-SPK) located in the ITE-part configured to play sound to the user and to provide the acoustic anti-occlusion signal (S_{AOC}) in dependence of the electric anti-occlusion signal (x_{AOC}). In the embodiment of FIG. 2B, the electric anti-occlusion signal (x_{AOC}) is fed to the second output transducer (EC-SPK) via a digital to analogue converter (DA), for conversion of the processed (digital electric) signal (x_{AOC}) to an analogue version (s_{AOC}). The second output transducer (EC-SPK) may be specifically adapted to play low frequency sound, e.g. at frequencies below a threshold frequency, e.g. smaller than or equal to 1 kHz, or smaller than or equal to 600 Hz.

The hearing aid (HD) further comprises an energy source, e.g. a battery (BAT), e.g. a rechargeable battery, for energizing the components of the device.

FIG. 3 shows a simplified block diagram of an embodiment of a hearing aid comprising a first embodiment of an active anti-occlusion cancellation system according to the present disclosure. The hearing aid (HD) is configured to be worn by a user at or in an ear of the user. The hearing aid comprises an ITE-part adapted for being located at or in an ear canal of the user. The hearing aid comprises at least one first input transducer (here a microphone M) configured to pick up sound (S) at the hearing aid and to provide corresponding at least one first electric input signal (x) representing sound. The hearing ad comprises a hearing aid processor (HLC) configured to provide a processed signal (x_{HA}) in dependence of the at least one electric input signal (x). The hearing aid comprises a first output transducer (HA-SPK) (here a loudspeaker) configured to play sound (S_{HAG}) to the user in dependence of said processed signal (x_{HA}), or a signal dependent thereon (x_{HAC}).

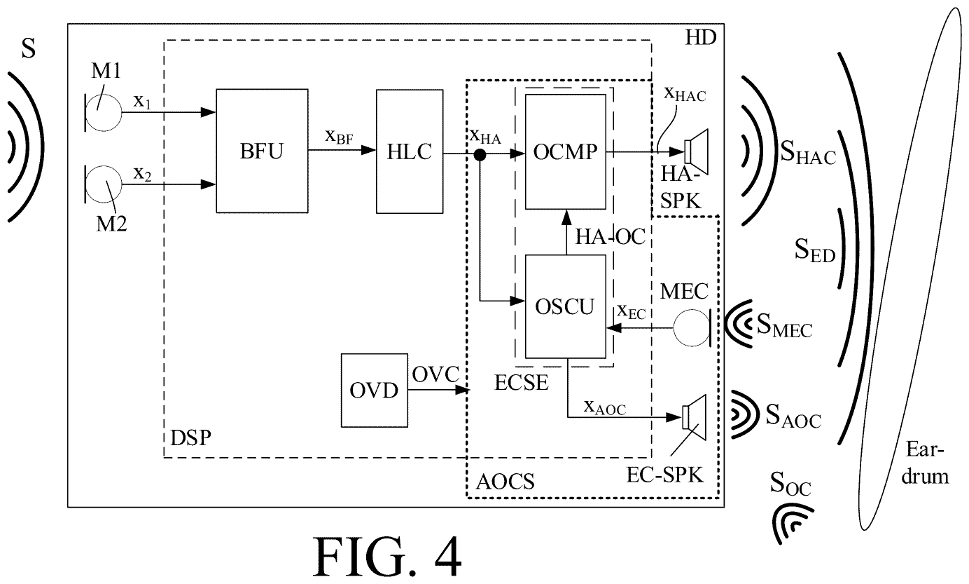

The hearing aid further comprises an active occlusion cancellation system (AOCS) for providing an acoustic anti-occlusion signal (S_{AOC}) configured to cancel or diminish a sense of occlusion of the user when the user is speaking, or chewing, or otherwise using his or her voice or facial bones or flesh, e.g. jaws (such activity providing the occluded sound S_{OC}, see e.g. FIGS. 2A, 2B, 4). The active occlusion cancellation system (AOCS) comprises an ear canal input transducer (here a microphone (MEC)) located in the ITE-part and configured to provide an electric ear canal input signal (x_{EC}) representing sound (S_{MEC}) in the ear canal, when the user wears the hearing aid. The sound (S_{MEC}) picked up by the ear canal microphone (MEC) is a sum of contributions from the two output transducers (HA-SPK, EC-SPK) and the occluded sound (S_{OC}, and possible further sound directly propagated (e.g. leaked) from the environment), cf. symbolic summation unit (‘+’) in the residual volume (Res. vol) receiving dashed bold arrows from the mentioned sources and providing a resulting input to the ear canal microphone (MEC) in FIG. 2B). The hearing aid (e.g. the active occlusion cancellation system (AOCS)) further comprises an ear canal sound estimation unit (ECSE) configured to estimate sound in the ear canal originating from the user's voice, etc., and to provide an electric anti-occlusion signal (x_{AOC}) in dependence of the electric ear canal input signal (x_{EC}) and the processed signal (x_{HA}). The active occlusion cancellation system (AOCS) further comprises a second (anti-occlusion) output transducer (EC-SPK) located in the ITE-part and configured to play anti-occlusion sound (S_{AOC}) to the user and to provide the acoustic anti-occlusion sound signal in dependence of the electric anti-occlusion signal (x_{AOC}). The ear canal sound estimation unit (ECSE) is further configured to provide a compensated processed signal (x_{HAC}) in dependence of the electric ear canal input signal (x_{EC}) and the processed signal (x_{HA}). The compensated processed signal (x_{HAC}) is compensated by an amount corresponding to the part of the sound (S_{HAC}) from the hearing aid loudspeaker (HA-SPK) that is cancelled by the acoustic anti-occlusion signal (S_{AOC}). Such compensation is described in a number of prior art documents, e.g. US2008063228A1, or EP3588985A1. Thereby a mixture of the sound played by the (first) hearing aid loudspeaker (HA-SPK) and the (second) anti-occlusion loudspeaker (EC-SPK) ideally cancels (and in practice attenuates) the occluded sound (S_{OC}) in the ear canal (e.g. in an occluded (or residual) volume between the ITE-part and the eardrum of the user).

In the embodiment of FIG. 3, the active occlusion cancellation system (AOCS) comprises the ear canal sound estimation unit (ECSE), the ear canal microphone (MEC) and the anti-occlusion loudspeaker (EC-SPK). In the embodiment of FIG. 3, the hearing aid processor (HLC) and the ear canal sound estimation unit (ECSE) are implemented in a digital signal processor (DSP) of the hearing aid (HD).

FIG. 4 shows a simplified block diagram of an embodiment of a hearing aid comprising a second embodiment of an active anti-occlusion cancellation system according to the present disclosure. The embodiment of FIG. 4 is similar to the embodiment of FIG. 3 (comprises the same functional blocs and input-output units). But in addition, the embodiment of FIG. 4 comprises two (at least one) input transducers (microphones M1, M2), and a beamformer filtering unit (BFU) connected to the input transducers (M1, M2) and the hearing aid processor (HLC). Further, in the exemplary embodiment of FIG. 4, the ear canal sound estimation unit (ECSE) is partitioned in a forward path compensation unit (OCMP) and an occluded sound control unit (OSCU). The forward path compensation unit (OCMP) is configured to provide that the compensated processed signal (x_{HAC}) is compensated by an amount corresponding to the part of the sound (S_{HAC}) from the hearing aid loudspeaker (HA-SPK) that is cancelled by the acoustic anti-occlusion signal (S_{AOC}) provided by the anti-occlusion loudspeaker (EC-SPK). The forward path compensation unit (OCMP) is configured to provide the compensated processed signal (x_{HAC}) in dependence of the forward path compensation control signal (HA-OC) provided by the occluded sound control unit (OSCU) in dependence of electric ear canal input signal (x_{EC}) from the ear canal microphone (MEC) (or from a signal originating therefrom) and the processed signal (x_{HA}) from the hearing aid processor (HLC).

FIG. 4 shows a simplified block diagram of an embodiment of a hearing aid comprising an active occlusion cancellation system according to the present disclosure. The hearing aid (HD) may be adapted for being located at or in an ear of a user. The hearing aid comprises a forward path for processing an audio input signal and providing a (preferably) improved, processed, signal intended for presentation to the user. The forward path comprises first and second microphones (M1, M2), configured to pick up environment sound (S) from the environment around the user when the user is wearing the hearing aid (HD). The two microphones provide respective (e.g. analogue or digitized) electric input signals (x₁, x₂) representative of the environment sound. The forward path further comprises (an optional) directional system (BFU) implementing one or more beamformers and providing one or more beamformed signals, here beamformed signal (x_{BF}). The forward path further comprises a hearing aid signal processor (HLC) for processing the beamformed signal (x_{BF}) and providing a processed signal (x_{HA}), e.g. configured to compensate for a hearing impairment of the user. The forward path further comprises a loudspeaker (HA-SPK) connected to a loudspeaker sound outlet of the hearing aid and configured to provide an output sound (S_{HAC}) to an eardrum (Eardrum) of the user in dependence of the processed signal (x_{HA}) or a signal (x_{HAC}) originating therefrom.

The hearing aid (HD) further comprises an active occlusion cancellation system (AOCS) (cf. dotted outline in FIG. 4) for providing an acoustic anti-occlusion signal (S_{AOC}) configured to cancel or diminish a sense of occlusion of the user when the user is speaking or otherwise using his or her voice, or jaws, etc. The active occlusion cancellation system (AOCS) comprises an ear canal input transducer (here microphone MEC) configured to provide an electric ear canal input signal (x_{EC}) representing sound in the ear canal, when the user wears the hearing aid. The active occlusion cancellation system (AOCS) further comprises an ear canal sound estimation unit (ECSE) configured to estimate sound in the ear canal in dependence of the electric ear canal input signal (x_{EC}) and to provide an electric anti-occlusion signal (x_{AOC}). The ear canal sound estimation unit (ECSE) may additionally (as also illustrated in FIG. 3) receive the processed signal (x_{HA}), and be configured to estimate sound in the ear canal originating from the user's voice, etc., in dependence of the electric ear canal input signal (x_{EC}) as well as the processed signal (x_{HA}). The active occlusion cancellation system (AOCS) further comprises a second (separate) output transducer (here a loudspeaker (EC-SPK) configured to provide the acoustic anti-occlusion signal in dependence of (based on) the electric anti-occlusion signal (x_{AOC}).

Depending on the design of the anti-occlusion system, the forward path may also include compensation for the attenuation that may be introduced by the anti-occlusion feedback loop. The anti-occlusion system attenuates the signal (x_{EC}) that is picked up by the ear canal input transducer (MEC), including the desired signal from the forward path of the hearing aid (comprising amplified environment sound to be presented to the user). Hence, it may be beneficial to compensate the signal of the forward path. The compensation is in the embodiment of FIG. 4 provided by forward path compensation unit (OCMP) as indicated above.

The hearing aid may further comprise an own voice detector (OVD) providing an own voice control signal (OVC) indicative of whether or not or with what probability a current input signal comprises the ser's own voice. The own voice control signal may be used as input to the active occlusion cancellation system (AOCS), e.g. to activate or deactivate the system. Thereby the active occlusion cancellation system may be enabled when the user's own voice is present (or present with a probability above a threshold value (e.g. 50%)), and disabled when not. Own voice control of the active occlusion cancellation system (AOCS) may be used in all other embodiments of the hearing aid of the present disclosure.

The hearing aid (HD) may e.g. be partitioned in a BTE-part (BTE), and ITE-part (ITE) and an (inter)connecting element (IC) as e.g. illustrated in FIG. 1 and FIG. 2A. The (first) microphones (M1, M2, denoted M_{BTE1}, M_{BTE2} in FIG. 2A) may be located in the BTE-part (as in FIG. 2A) or in the ITE-part (s in FIG. 2B) or distributed between the BTE-part and the ITE-part. The ear canal microphone (MEC) may e.g. be located in the ITE-part facing the ear drum (as illustrated in FIG. 1, 2A, 2B, 3, 4). The second (separate) loudspeaker (EC-SPK) may e.g. be located in the ITE-part (as illustrated in FIG. 1, 2A, 2B, 3, 4). The (first) normal hearing aid loudspeaker (HA-SPK) may e.g. be located in the BTE-part (cf. FIG. 2A) or other part different from the ITE-part. The (first) normal hearing aid loudspeaker (HA-SPK) may (alternatively) e.g. be located in the ITE-part (cf. FIG. 2B). The ear canal sound estimation unit (ECSE) may be located in the BTE-part or in the ITE-part, or distributed between the BTE-part and the ITE-part.

The hearing aid (HD) may, however, also be of a ‘completely in the ear canal’ (CIC) type, see e.g. FIG. 2B. In such case, all components of the hearing aid (including the extra ear canal loudspeaker) may be located in the CIC-hearing aid.

The hearing aid may further comprise one or two earpieces (each for being located at least partially in an ear canal of the user) connected to a separate processing unit. At least some, such as all of the input and output transducers of a hearing aid according to the present disclosure may be located in an earpiece. At least the normal hearing aid loudspeaker (HA-SPK), the anti-occlusion loudspeaker (EC-SPK), and the ear canal microphone (MEC) may be located in an earpiece for a particular ear. The hearing aid microphone(s) (M, M1, M2) may also be located in an earpiece. The processing of the signals picked up by the microphones of the hearing aid may be performed in a separate processing unit. The processing related to generating the anti-occlusion signals (x_{AOC}, x_{HAC}, cf. FIG. 3, 4, 5B, 5C), e.g. embodied in the ear canal sound estimation unit (ECSE), may e.g. be performed in the earpiece.

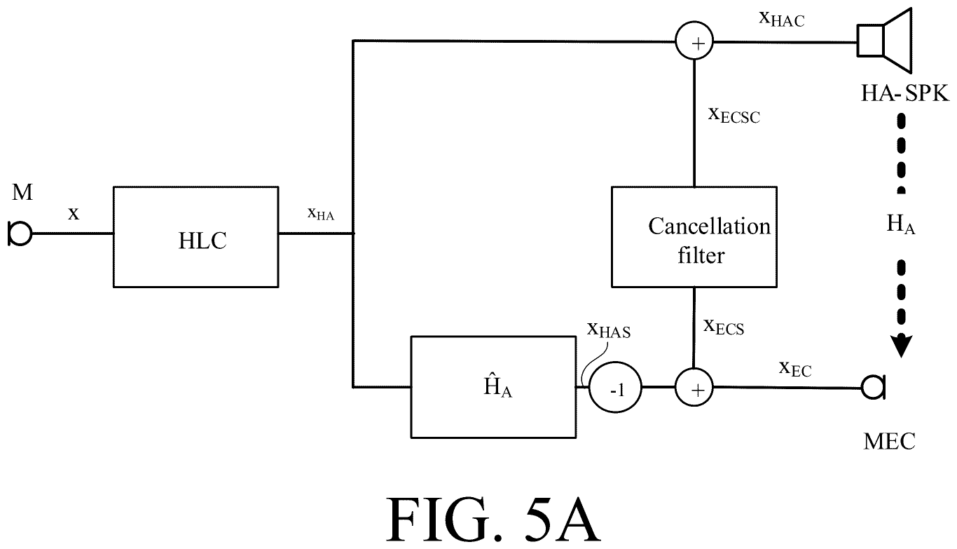

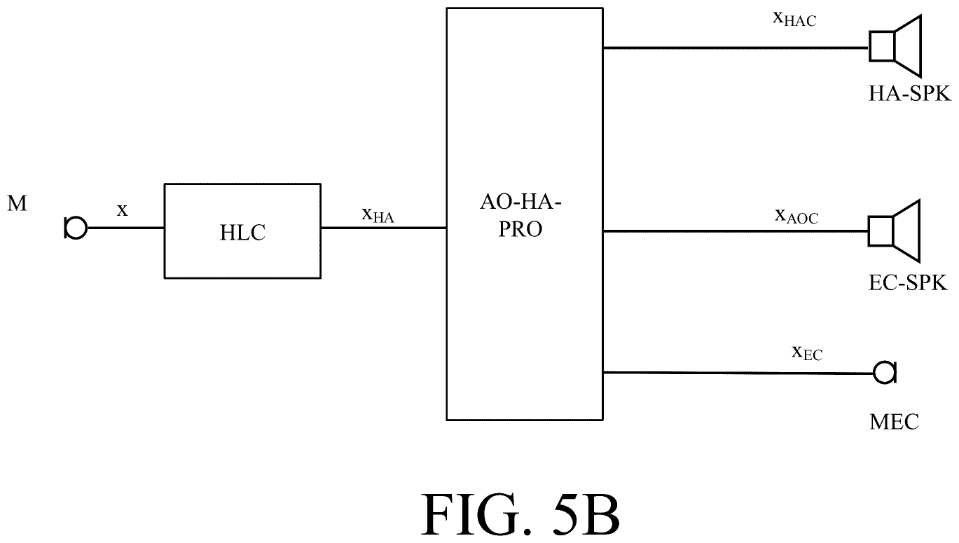

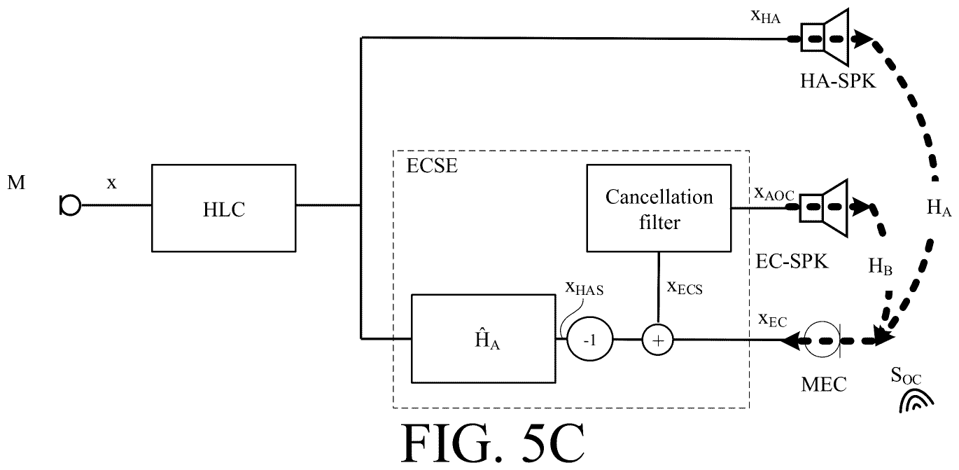

FIG. 5A shows a conventional anti-occlusion system. ‘Ĥ_{A}’ is a filter implementing an estimate of the transfer function (H_{A}, cf. bold dashed arrow denoted ‘H_{A}’) from the (electrical input to the) normal hearing aid loudspeaker (HA-SPK) to the (electrical output of the) ear canal microphone (MEC). The HLC-block is the hearing aid processor representing conventional hearing aid processing (HLC stands for hearing loss compensation) providing the processed signal (x_{HA}) in dependence of an electric input signal (x) provided by a microphone (M). The filter (Ĥ_{A}) filters the processed signal (x_{HA}) and the filtered signal (x_{HAS}) is subtracted from the ear canal microphone signal (x_{EC}) in a subtraction unit (‘−1’ followed by ‘+’). Thereby an estimate of the part of the ear canal microphone signal (x_{EC}) originating from the normal hearing aid loudspeaker (HA-SPK) is subtracted from the ear canal microphone signal (x_{EC}) resulting in compensated ear canal signal (x_{ECS}) which is fed to a ‘cancellation filter’. The ‘cancellation filter’ provides hearing aid processing modification signal (x_{ECSC}), which is added to the processed signal (x_{HA}) to provide a compensated output signal (x_{HAC}). The compensated output signal (x_{HAC}) is played to the eardrum by the normal hearing aid loudspeaker (HA-SPK).

FIG. 5B shows a first embodiment of an anti-occlusion system with two loudspeakers according to the present disclosure. The normal hearing aid loudspeaker (HA-SPK) may be used fundamentally as in a state-of-the-art hearing aid of FIG. 5A. The separate ear canal (anti-occlusion) loudspeaker (EC-SPK) may be specifically adapted for anti-occlusion and configured to play an anti-occlusion signal at the eardrum based on an anti-occlusion signal (x_{AOC}) provided by the anti-occlusion processing block (denoted ‘AO-HA-PRO’ in FIG. 5B). The anti-occlusion processing block provides output signals (x_{HAC}, x_{AOC}) to the normal hearing aid loudspeaker (HA-SPK) and to the separate ear canal (anti-occlusion) loudspeaker (EC-SPK), respectively, based on inputs (x_{HA}, x_{EC}) from the hearing aid processor (HLC, the processed signal (x_{HA}) being based on the electric input signal (x) from an environment facing microphone (M)) and from the ear canal microphone (MEC), respectively. The ‘AO-HA-PRO’ block in FIG. 5B may e.g. be embodied by the ear canal sound estimation unit (ECSE) in FIG. 3, 4 or 5C, generating the (possibly modified) hearing loss compensation signal (x_{HAC}, possibly x_{HA}) and an anti-occlusion signal (x_{AOC}) based on the ear canal microphone signal (x_{EC}) and the processed signal (x_{HA}) from the hearing aid processor.

FIG. 5C shows a second embodiment of an anti-occlusion system with two loudspeakers (HA-SPK, EC-SPK) according to the present disclosure. The transfer function (H_{A}) for sound from the (electrical input to the) normal hearing aid loudspeaker (HA-SPK) to the (electrical output from the) ear canal microphone (MEC), indicated by dashed arrow (H_{A}) in FIG. 5C, is estimated by filter (Ĥ_{A}) (as in FIG. 5A). In other words, the transfer function (H_{A}) may be assumed to include the transfer functions of the normal hearing aid loudspeaker and the ear canal microphone, respectively, as indicated by the bold dashed arrows in FIG. 5C. In addition to the distance between and properties of the involved components (HA-SPK, MEC), the transfer function (H_{A}) is dependent on the ear canal acoustics (size of the ear, possible leakage paths, etc.). In the embodiment of FIG. 5C, the processed signal (x_{HA}) from the hearing aid processor (HLC) is fed directly to the normal hearing aid loudspeaker (HA-SPK) for presentation to the user's eardrum. As in the state-of-the-art anti-occlusion system of FIG. 5A, the filter (Ĥ_{A}) of FIG. 5C filters the processed signal (x_{HA}) and the filtered signal (x_{HAS}) is subtracted from the ear canal microphone signal (x_{EC}) in a subtraction unit (‘−1’ followed by ‘+’). Thereby an estimate of the part of the ear canal microphone signal (x_{EC}) originating from the normal hearing aid loudspeaker (HA-SPK) is subtracted from the ear canal microphone signal (x_{EC}) resulting in compensated ear canal signal (x_{ECS}), which is fed to the ‘cancellation filter’ (e.g. et ANC-feedback cancellation filter). The ‘cancellation filter’ provides an anti-occlusion compensation signal (x_{AOC}), which is fed to the separate (anti-occlusion) loudspeaker and played to the eardrum of the user to thereby reduce the perception of occlusion by the user. The ‘cancellation filter’, the filter (Ĥ_{A}) and the subtraction unit (‘−1’ followed by ‘+’) constitute or form part of an ear canal sound estimation unit (ECSE) as indicated by the dashed rectangular enclosure (denoted ‘ECSE’) in FIG. 5C. The filter (Ĥ_{A}) of FIG. 5C may be a fixed filter, wherein the transfer function (H_{A}) is estimated in advance of use of the hearing aid (e.g. on a model or on a human being, e.g. the user). Alternatively, the filter coefficients of the filter (Ĥ_{A}) may be adaptively updated (e.g. after a power-up of the hearing aid, where the hearing aid(s) is (are) freshly mounted at the ears of the user, or regularly, such as continuously). Likewise, the ‘cancellation filter’ may be a fixed filter or an adaptively updated filter based on an estimate of the transfer function (H_{B}) from the (electrical input to the) separate ear canal loudspeaker (EC-SPK) to the (electrical output from the) ear canal microphone (MEC), as indicated by the bold dashed arrows in FIG. 5C.

In common of the embodiments of FIGS. 3, 4, 5B, and 5C, the hearing aid loudspeaker (HA-SPK) may e.g. be located in a part of the hearing aid located away from the ear canal of the user, e.g. in a part adapted for being located in or at or behind pinna. The hearing aid loudspeaker (HA-SPK) may, however, be located in an earpiece adapted for being fully or partially located in an ear canal of the user (e.g. together with the separate ear canal loudspeaker (EC-SPK), cf. e.g. FIG. 2B).

It is intended that the structural features of the devices described above, either in the detailed description and/or in the claims, may be combined with steps of the method, when appropriately substituted by a corresponding process.

As used, the singular forms “a,” “an,” and “the” are intended to include the plural forms as well (i.e. to have the meaning “at least one”), unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will also be understood that when an element is referred to as being “connected” or “coupled” to another element, it can be directly connected or coupled to the other element, but an intervening element may also be present, unless expressly stated otherwise. Furthermore, “connected” or “coupled” as used herein may include wirelessly connected or coupled. As used herein, the term “and/or” includes any and all combinations of one or more of the associated listed items. The steps of any disclosed method are not limited to the exact order stated herein, unless expressly stated otherwise.

It should be appreciated that reference throughout this specification to “one embodiment” or “an embodiment” or “an aspect” or features included as “may” means that a particular feature, structure or characteristic described in connection with the embodiment is included in at least one embodiment of the disclosure. Furthermore, the particular features, structures or characteristics may be combined as suitable in one or more embodiments of the disclosure. The previous description is provided to enable any person skilled in the art to practice the various aspects described herein. Various modifications to these aspects will be readily apparent to those skilled in the art, and the generic principles defined herein may be applied to other aspects.

The claims are not intended to be limited to the aspects shown herein but are to be accorded the full scope consistent with the language of the claims, wherein reference to an element in the singular is not intended to mean “one and only one” unless specifically so stated, but rather “one or more.” Unless specifically stated otherwise, the term “some” refers to one or more.

### REFERENCES

US2008063228A1 (Hearworks) 13.03.2008
EP3588985A1 (GN Hearing) 01.01.2020
U.S. Pat. No. 8,229,127B2 (Oticon) 12.02.2009
EP3588981A1 (Oticon) 01.01.2020

1. A hearing aid configured to be worn by a user at or in an ear of the user, the hearing aid comprising:
an ITE-part adapted for being located at or in an ear canal of the user;
at least one first input transducer configured to provide corresponding at least one first electric input signal representing sound;
a hearing aid processor configured to provide a processed signal in dependence of said at least one electric input signal;
a first output transducer configured to play sound to the user in dependence of said processed signal, or a signal dependent thereon;
an active occlusion cancellation system for providing an acoustic anti-occlusion signal configured to cancel or diminish a sense of occlusion of the user when the user is speaking, or otherwise is using his or her voice, or when otherwise moving the jaws; wherein the active occlusion cancellation system comprises:
an ear canal input transducer located in said ITE-part and configured to provide an electric ear canal input signal representing sound in said ear canal, when the user wears the hearing aid;
an ear canal sound estimation unit configured to estimate sound in said ear canal and to provide an electric anti-occlusion signal in dependence of said electric ear canal input signal and said processed signal;
a second output transducer located in said ITE-part configured to play sound to the user and to provide said acoustic anti-occlusion signal in dependence of said electric anti-occlusion signal, wherein said second output transducer is specifically adapted to provide sound at frequencies below a threshold frequency.

2. A hearing aid according to claim 1 comprising a BTE-part adapted for being located at or behind the ear of the user and a connecting element adapted for mechanically and electrically connecting said BTE-part and said ITE-part.

3. A hearing aid according to claim 2 wherein said first output transducer is located in said BTE-part.

4. A hearing aid according to claim 1 wherein said at least one first input transducer comprises a microphone.

5. A hearing aid according to claim 1 wherein said at least one first input transducer comprises an audio receiver.

6. A hearing aid according to claim 1 wherein said first or second output transducer comprises a loudspeaker.

7. A hearing aid according to claim 1 wherein said second output transducer is specifically adapted to provide sound at frequencies below a threshold frequency smaller than or equal to 1 kHz.

8. A hearing aid according to claim 1 configured to provide that the first and second output transducers play sound in different frequency ranges.

9. A hearing aid according to claim 8, configured to provide that the first output transducer plays sound above a first threshold frequency (f_{th,1}), and that the second output transducer plays sound below a second threshold frequency (f_{th,2}), wherein the first threshold frequency (f_{th,1}) is smaller than or equal to the second threshold frequency (f_{th,2}).

10. A hearing aid according to claim 1 wherein said connecting element comprises an acoustic tube.

11. A hearing aid according to claim 1 comprising an own voice detector configured to estimate whether or not, or with what probability, a given input sound originates from the voice of the user and to provide an own voice control signal in dependence thereof.

12. A hearing aid according to claim 1 comprising a movement detector configured to detect said movement of the jaws of the user, and to provide a jaw movement control signal in dependence thereof.

13. A hearing aid according to claim 11 wherein the ear canal sound estimation unit (ECSE) is configured to provide said electric anti-occlusion signal in dependence of said own voice control signal and/or said jaw movement control signal.

14. A hearing aid according to claim 11 configured to operate in different modes, including an anti-occlusion-mode wherein the active occlusion cancellation system is enabled, and where the anti-occlusion-mode is enabled or disabled in dependence of said own voice control signal and/or said jaw movement control signal.

15. A hearing aid according to claim 14 wherein the change of enabling and disabling the anti-occlusion cancellation system may be associated with a fading scheme providing a gradual change over time from one mode of operation to another.

16. A hearing aid according to claim 1 wherein the first output transducer is a tweeter and the second output transducer is a woofer.

17. A binaural hearing aid system comprising first and second hearing aids according to claim 1, wherein the first and second hearing aids are configured to establish a communication link between them allowing a coordination of enabling and disabling the anti-occlusion cancellation system.

18. A method of operating a hearing aid configured to be worn by a user at or in an ear of the user, the hearing aid comprising:
an ITE-part adapted for being located at or in an ear canal of the user;
at least one first input transducer configured to provide corresponding at least one first electric input signal representing sound;
a hearing aid processor configured to provide a processed signal in dependence of said at least one electric input signal;
a first output transducer configured to play sound to the user in dependence of said processed signal, or a signal dependent thereon;
an ear canal input transducer located in said ITE-part and configured to provide an electric ear canal input signal representing sound in said ear canal, when the user wears the hearing aid;
a second output transducer located in said ITE-part configured to play sound to the user; the method comprising:
providing an acoustic anti-occlusion signal configured to cancel or diminish a sense of occlusion of the user when the user is speaking, or otherwise is using his or her voice, or when otherwise moving the jaws;
estimating sound in said ear canal and to provide an electric anti-occlusion signal in dependence of said electric ear canal input signal and said processed signal; and, providing via said second output transducer an acoustic anti-occlusion signal to the user's ear canal in dependence of said electric anti-occlusion signal, wherein said second output transducer is specifically adapted to provide sound at frequencies below a threshold frequency.

19. A hearing aid configured to be worn by a user at or in an ear of the user, the hearing aid comprising:
an ITE-part adapted for being located at or in an ear canal of the user;
a BTE-part adapted for being located at or behind the ear of the user; and
a connecting element adapted for mechanically and electrically connecting said BTE-part and said ITE-part
at least one first input transducer configured to provide corresponding at least one first electric input signal representing sound;
a hearing aid processor configured to provide a processed signal in dependence of said at least one electric input signal;
a first output transducer located in said BTE-part configured to play sound to the user in dependence of said processed signal, or a signal dependent thereon, said first output transducer being specifically adapted to frequencies above a threshold frequency;
an active occlusion cancellation system for providing an acoustic anti-occlusion signal configured to cancel or diminish a sense of occlusion of the user when the user is speaking, or otherwise is using his or her voice, or when otherwise moving the jaws; wherein the active occlusion cancellation system comprises
an ear canal input transducer located in said ITE-part and configured to provide an electric ear canal input signal representing sound in said ear canal, when the user wears the hearing aid;
an ear canal sound estimation unit configured to estimate sound in said ear canal and to provide an electric anti-occlusion signal in dependence of said electric ear canal input signal and said processed signal;
a second output transducer located in said ITE-part configured to play sound to the user and to provide said acoustic anti-occlusion signal in dependence of said electric anti-occlusion signal, wherein said second output transducer is specifically adapted to provide sound at frequencies below said threshold frequency.

20. A hearing aid according to claim 19 wherein said threshold frequency is in the range between 400 Hz and 800 Hz.
